(19) United States
(12) Patent Application Publication
(10) Pub. No.: US 2012/0105588 A1
(43) Pub. Date: May 3, 2012

(54) IMAGE CAPTURE DEVICE

(75) Inventor: Takashi YAMAMOTO, Osaka (JP)

(73) Assignee: PANASONIC CORPORATION, Osaka (JP)

(21) Appl. No.: 13/216,826

(22) Filed: Aug. 24, 2011

(30) Foreign Application Priority Data
Oct. 28, 2010 (JP) 2010-241631

(51) Int. Cl. H04N 13/02; H04N 5/225

(52) U.S. Cl. 348/46; 348/333.01; 348/E05.024; 348/E13.074

(57) ABSTRACT

An image capture device, to/from which a piece of equipment for use to shoot video or record audio is attachable and removable, includes: a communications section adapted to get, when such a piece of equipment is attached to the device, property information of the piece of equipment; a processor adapted to determine, by reference to the property information, whether a user interface to control the operation of the piece of equipment needs to be displayed or not; a display section adapted to display the user interface when instructed by the processor to do so; and a touchscreen panel adapted to allow the user to operate the user interface.

### BACKGROUND OF THE INVENTION

1. Field of the Invention

The present invention relates to an image capture device such as a still camera or a camcorder. More particularly, the present invention relates to an image capture device which includes a display section that displays a user interface thereon and to/from which an accessory (such as an interchangeable lens, a 3D lens, a flash unit or a microphone) is readily attachable and removable.

2. Description of the Related Art

An image capture device, to which a so-called “motorized zooming interchangeable lens” is attachable, is known. The motorized zooming interchangeable lens is a zoom lens to be driven by a motor, for example. Japanese Patent Application Laid-Open Publication No. 10-10405 discloses an image capture device in which the user can control the motorized zoom function of an interchangeable lens by operating the interface from the camera body side.

Specifically, the image capture device has a zoom lever for changing the zoom power on the camera body, to which an interchangeable lens is attached. When using such an image capture device, the user can change the zoom power of the interchangeable lens by turning that zoom lever. In this manner, he or she can change the angle of view of an image to capture.

Although that conventional image capture device has a zoom lever, not every interchangeable lens attached to the image capture device has the motorized zoom function. Also, even if the given interchangeable lens has the motorized zoom function, the interchangeable lens cannot always be controllable from the camera body side, once the lens has been attached to the body. That is why a zoom lever on the image capture device may be unusable according to the combination with the interchangeable lens. Such an unusable zoom lever would rather decrease the handiness of the image capture device for users.

Such a problem can certainly be avoided if the camera body of the image capture device has no zoom levers. In that case, however, even if an interchangeable lens with the motorized zoom function is attached to the camera body with no zoom levers, the user may fail to notice that that interchangeable lens has the motorized zoom function. Or even if he or she notices that the interchangeable lens has the motorized zoom function but if the camera body has no zoom levers, then the interchangeable lens is physically unusable.

### SUMMARY OF THE INVENTION

It is therefore an object of the present invention to increase the handiness of an image capture device to which an interchangeable lens with the motorized zoom function or any other piece of equipment is attachable.

An image capture device according to a preferred embodiment of the present invention is a device, to/from which a piece of equipment for use to shoot video or record audio is attachable and removable. The device includes: a communications section for getting, when such a piece of equipment is attached to the device, the property information of the piece of equipment; a processor adapted to determine, by reference to the property information, whether a user interface to control the operation of the piece of equipment needs to be displayed or not; a display section adapted to display the user interface when instructed by the processor to do so; and a touchscreen panel adapted to allow the user to operate the user interface.

The piece of equipment may be an interchangeable lens. The communications section may communicate with the interchangeable lens to get the property information from the interchangeable lens. And the display section may display the user interface to control the interchangeable lens' operation.

By reference to the property information, the processor may determine that the user interface to control the interchangeable lens' operation needs to be displayed, and the display section may display the user interface as instructed by the processor.

In response to the user's touch on the touchscreen panel while the user interface is being displayed on the display section, the processor may control the interchangeable lens' operation.

The interchangeable lens may be a zoom lens. In response to the user's touch on the touchscreen panel, the processor may control the focal length or zoom power of the zoom lens.

The processor may be able to display one of multiple different kinds of user interfaces that have been prepared in advance.

The image capture device may be able to change its modes of operation from a still picture shooting mode into a moving picture shooting mode, and vice versa. The display section may display a first user interface while the device is operating in the still picture shooting mode and may display a second user interface, which is different from the first user interface, while the device is operating in the moving picture shooting mode.

The processor may display one of the multiple different kinds of user interfaces that has been chosen by the user.

The first user interface may include a slider bar that allows the user to select an arbitrary focal length, and the second user interface may include a button that allows the user to change the focal length at a constant rate while being pressed down.

The piece of equipment may be a flash unit. The communications section may get the property information from the flash unit. The display section may display a user interface to control the flash unit's firing.

The piece of equipment may be a microphone. The communications section may get the property information from the microphone. The display section may display a user interface to control at least one of the sensitivity and the directivity of the microphone.

The piece of equipment may be a 3D conversion lens. The communications section may get the property information from the 3D conversion lens. The display section may display a user interface to control at least one of the two optical axes of the 3D conversion lens that are associated with a right-eye image and a left-eye image, respectively.

The processor may retain a standard that designates pieces of equipment, of which the operation is controllable for the processor. By comparing the property information to the standard, the processor may determine whether or not the processor is able to control the operation of the piece of equipment attached.

The processor may retain, as the standard, a list of pieces of equipment, of which the operation is controllable for the processor.

The processor may retain standard information as the standard. If the property information gotten agrees with the standard information, the processor may find the operation of the piece of equipment attached controllable.

According to the present invention, when a motorized zooming interchangeable lens or any other piece of equipment that is controllable from the camera body side is attached to the camera body, a user interface to control that piece of equipment is displayed. As a result, the image capture device can be used much more handily.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates the general appearance of a digital camera 1 as a preferred embodiment of the present invention.

FIG. 2 schematically illustrates the respective internal configurations of the interchangeable lens 2 and the camera body 3 that form the digital camera 1.

FIG. 3 is a flowchart illustrating how the images on the screen need to be changed as the interchangeable lens 2 is attached to the camera body 3.

FIG. 4 illustrates an example of a zoom controlling graphical user interface.

FIG. 5 illustrates another example of a zoom controlling graphical user interface.

FIG. 6 illustrates an example of an ordinary graphical user interface.

FIG. 7 illustrates a digital camera 1a that has a camera body 3a, to which not only an interchangeable lens 2 but also a flash unit 2a are attachable.

FIG. 8 illustrates an exemplary graphical user interface for controlling firing of the flash unit 2a.

FIG. 9 illustrates a digital camera 1b that has a camera body 3b, to which a microphone 2b is attachable.

FIG. 10 illustrates an exemplary graphical user interface for controlling the microphone 2b.

FIG. 11 illustrates a digital camera 1 that has a camera body 3, to which a 3D conversion lens 2d is attachable.

### DETAILED DESCRIPTION OF PREFERRED EMBODIMENTS

Hereinafter, preferred embodiments of an image capture device according to the present invention will be described with reference to the accompanying drawings.

To/from an image capture device according to a preferred embodiment of the present invention, a piece of equipment (or accessory) for shooting video or recording audio is attachable and removable. Examples of such “pieces of equipment for shooting video or recording audio” include an interchangeable zoom lens, a flash unit, a microphone and a 3D conversion lens.

When a piece of equipment is attached thereto, this image capture device gets the property information of the piece of equipment through a mount. And in accordance with the property information thus gotten, a microcomputer of the image capture device determines whether a user interface to control the operation of the piece of equipment attached needs to be displayed or not. If the answer is YES, the microcomputer instructs the display device to display the user interface to control that piece of equipment.

The user operates the user interface being displayed on the display device by tapping a touchscreen panel, which is provided for this image capture device. For example, if a zoom lens is attached, the user controls either the focal length or the zoom power of the zoom lens through the touchscreen panel. On the other hand, if a flash unit is attached, he or she controls the flash unit via the touchscreen panel. More specifically, the user controls the ON/OFF states of a TTL automatic dimming mode and a photometry mode (which may be evaluation metering, center-weighted average metering or spot metering). And if a microphone is attached, the user controls the directivity and/or sensitivity of the microphone by means of the touchscreen panel.

In the preferred embodiments of the present invention to be described below, the image capture device is supposed to be a digital still camera (which will be simply referred to herein as a “digital camera”), of which the lens is replaceable with an interchangeable lens. The digital camera can also be used to shoot a moving picture.

Hereinafter, the configuration and operation of a digital camera 1 as a preferred embodiment of the present invention will be described with reference to the accompanying drawings.

### 1-1. Configuration

### 1-1-1. General Configuration

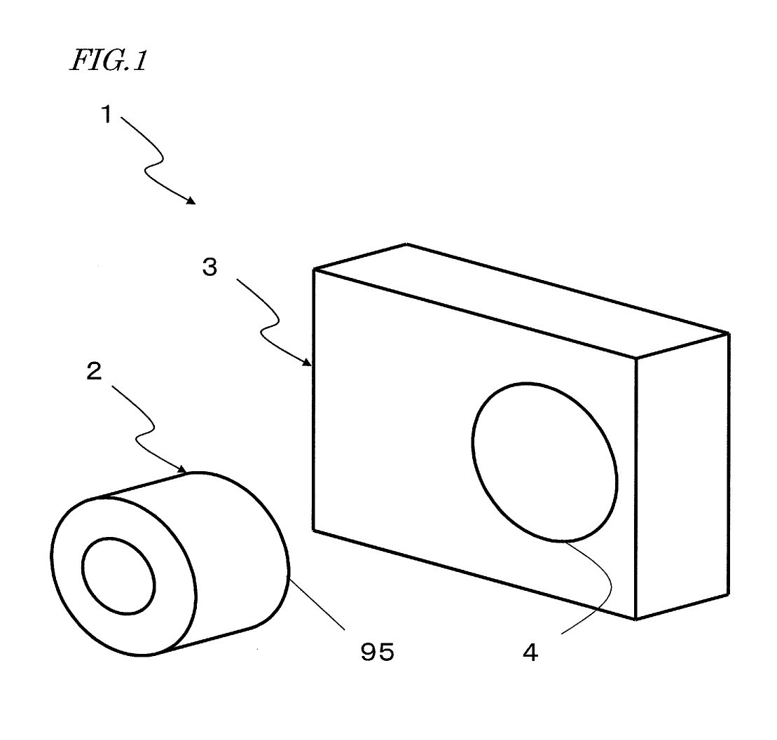

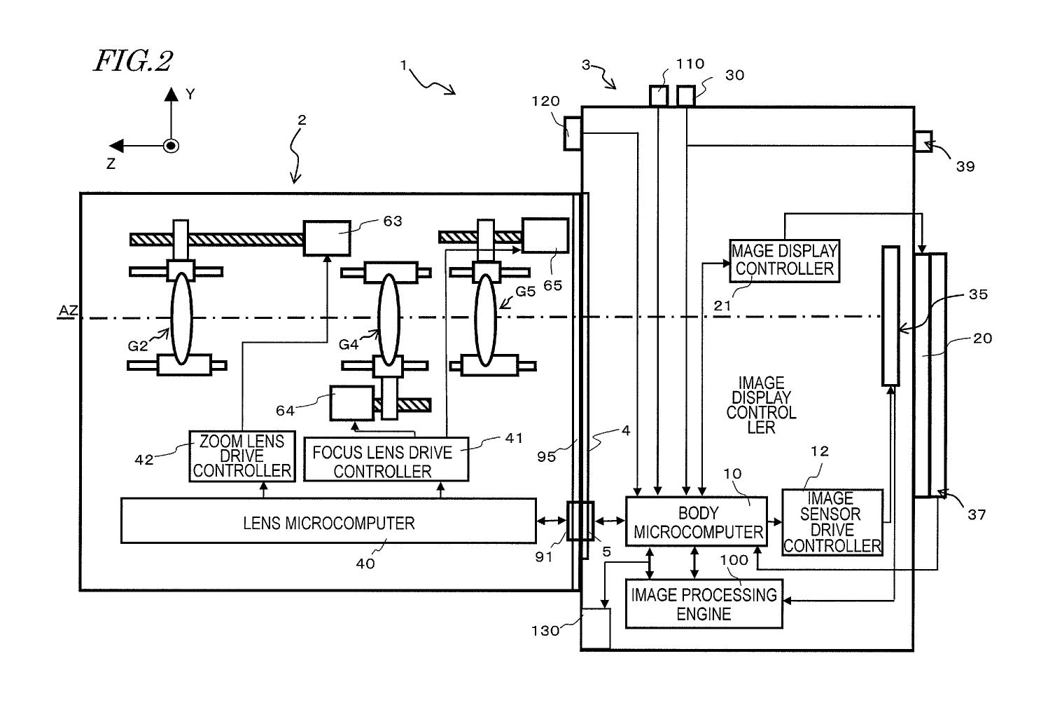

First of all, a lens replaceable digital camera 1 as a preferred embodiment of the present invention will be outlined with reference to FIGS. 1 and 2.

FIG. 1 illustrates the general appearance of the digital camera 1 of this preferred embodiment. The digital camera 1 includes an interchangeable lens 2 and a camera body 3. The interchangeable lens 2 is attached to a body mount 4 on the front side of the camera body 3 via a lens mount 95. The interchangeable lens 2 is removable from the camera body 3.

Now look at FIG. 2, which schematically illustrates the respective internal configurations of the interchangeable lens 2 and the camera body 3 that form this digital camera 1. Hereinafter, the internal configurations of the interchangeable lens 2 and the camera body 3 will be described.

### 1-1-2. Configuration of Interchangeable Lens 2

The interchangeable lens 2 includes a lens-side communications section 91, which forms an integral part of the lens part 95, and further includes a lens microcomputer 40, a focus lens drive controller 41, a zoom lens drive controller 42, focus motors 64, 65, a group of objective lenses (not shown), a group of correction lenses (not shown), a group G2 of zoom lenses, an groups G4 and G5 of focus lenses.

When the lens-side communications section 91 and a body-side communications section 5 are connected together, communications can be made between the lens microcomputer 40 and a body microcomputer 10.

The lens microcomputer 40 gives an instruction to the focus lens drive controller 41, which outputs a drive signal to the focus motors 64 and 65 in accordance with that instruction. And in response to the drive signals, the focus motors 64 and 65 drive the groups G4 and G5 of focus lenses, respectively, independently of each other. The focus motors 64 and 65 move the groups G4 and G5 of focus lenses along their optical axis, thereby changing the shooting distance (i.e., object distance).

The lens microcomputer 40 also gives an instruction to the zoom lens drive controller 42, which outputs a drive signal to the zoom motor 63 in accordance with that instruction. And in response to the drive signal supplied from the zoom lens drive controller 42, the zoom motor 63 drives the group G2 of zoom lenses.

### 1-1-3. Configuration of Camera Body 3

The camera body 3 includes the body mount 4 and the body-side communications section 5 that communicates with the interchangeable lens 2. The camera body 3 further includes a body microcomputer 10, an image processing engine 100, an image sensor drive controller 12, an image sensor 35, an image display controller 21, a display section 20, a touchscreen panel 37, a card slot (not shown) to/from which a memory card 130 is readily inserted and removed, a built-in microphone 120, a still picture shooting button 30, a moving picture shooting button 110 and a menu button 39.

The camera body 3 of this preferred embodiment may or may not have a zoom lever as a piece of hardware. This is because a graphical user interface (GUI) may be used as the zoom lever as will be described later.

The body-side communications section 5 and the lens-side communications section 91 can exchange data with each other. Examples of such data include the property information of the camera body 3 and the property information of the interchangeable lens 2. More specifically, the data to be exchanged includes lens specific data or lens attribute information, a focus drive control signal, a zoom drive control signal, an exposure sync signal, information indicating whether or not a moving picture is being recorded, and information indicating whether or not mute mode is ON. In this case, examples of the “lens attribute information” include the identification number of the interchangeable lens 2 and information about whether or not the zoom level of the interchangeable lens 2 is controllable from the camera body side.

The body microcomputer 10 gets data about the interchangeable lens 2 by way of the body-side communications section 5 and the lens-side communications section 91, thereby generating various kinds of control signals. For example, the body microcomputer 10 gets the lens attribute information from the lens microcomputer 40, thereby generating a camera control signal that makes this digital camera 1 operate based on the lens attribute.

The image sensor 35 transforms an optical image, which has been produced by the optical system of the interchangeable lens 2, into an electrical signal, thereby generating image data. And the image sensor 35 is driven and controlled with a timing signal generated by the image sensor drive controller 12. The image data generated by the image sensor 35 is supplied to the image processing engine 100, where the image data is subjected to various kinds of image processing.

The image processing engine 100 can perform various kinds of image processing on the image data that has been supplied from the image sensor 35. Examples of such image processing include YC conversion, white balance correction, gamma correction, zoom-in and zoom-out on/of an image, image compression and shrinkage, and in-focus state decision by detecting a contrast ratio value. Anyway, the image data that has been processed by the image processing engine 100 is written on the memory card 130 and then presented on the display section 20 by the image display controller 21.

The display section 20 may be an LCD, for example, and plays back and displays either a live monitor image or the image that has been written on the memory card 130 in accordance with the instruction given by the image display controller 21.

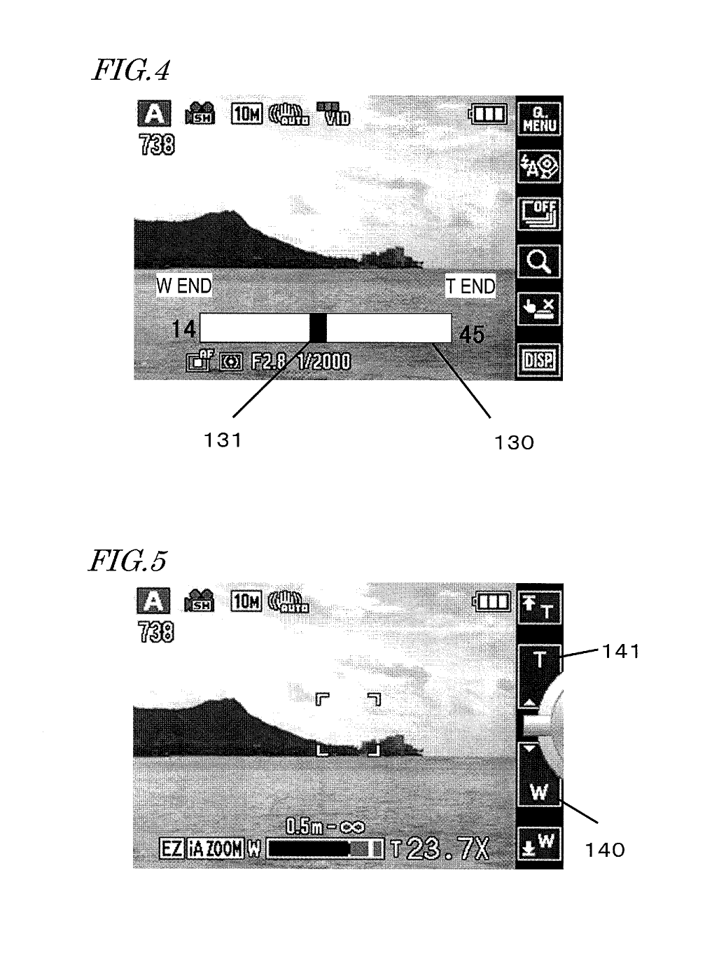

The image display controller 21 gets any of the GUI's shown in FIGS. 4 to 6 (to be described later) displayed on the display section 20 so that the user can perform various kinds of touch operations on it.

The touchscreen panel 37 is laid on the screen of the display section 20 and has a data entering area (not shown) through which the user can enter data by putting his or her finger(s), for example, on a part of the data entering area.

For example, if the display area of the display section 20 and the data entering area of the touchscreen panel 37 are laid one upon the other, a data entry point on the touchscreen panel 37 can be associated with a part of the display area of the display section 20. In that case, by sensing on what part of the data entering area the user has put his or her finger, the touchscreen panel 37 generates a signal indicating that part of the area. Based on that signal, the body microcomputer 10 determines exactly what part of the display area of the display section 20 has been touched by the user, and carries out its processing on the supposition that an image portion displayed in that part of the display area has been selected. In this preferred embodiment, the touchscreen panel 37 adopted is a capacitive touchscreen that is sensitive to the charge in the user's finger.

According to this preferred embodiment, the user operates the user interface being displayed on the display section 20 through the touchscreen panel 37, thereby operating the camera and the interchangeable lens 2 as intended.

The built-in microphone 120 converts the audio recorded into an electrical signal while a moving picture is being shot. As will be described later with reference to FIG. 9, an external microphone can also be connected to this digital camera 1. The external microphone to be connected preferably has directivity that is good enough to avoid recording the noise made by the drive sections of the interchangeable lens 2 or the noise made by the camera body 3. That is why when the external microphone is connected, only the external microphone may be used with the built-in microphone 120 turned OFF. While a moving picture is being shot, the body microcomputer 10 performs multiplexing processing in a predetermined format on the moving picture data that has been obtained by the image sensor 35 and on the audio data that has been obtained by the built-in microphone 120 and then A/D converted, thereby generating a moving picture file and writing it on the memory card 130.

The memory card 130 saves the still picture data or moving picture data that has been generated by the image sensor 35. The body microcomputer 10 can perform reading and writing various kinds of data from/on the memory card 130 through the card slot (not shown).

On the top of the camera body 3, arranged are the still picture shooting button (i.e., shutter release button) 30 and the moving picture shooting button 110. When the user presses any of these buttons, a shooting operation is carried out in the mode specified.

Specifically, the still picture shooting button 30 can be pressed down either halfway or fully. If the user presses the still picture shooting button 30 halfway, the body microcomputer 10 performs an autofocus control on the focus lens so that this digital camera 1 gets the subject right into focus. On the other hand, if the still picture shooting button 30 is pressed down fully, then the body controller 10 writes the still picture data that is generated when the button is pressed down on the memory card 130.

Meanwhile, if the user has pressed the moving picture shooting button 110, the body microcomputer 10 performs various kinds of operations to record a moving picture. For example, if the moving picture shooting button 110 has been pressed down fully by the user, then the body microcomputer 10 starts getting audio data generated by the built-in microphone 120 and moving picture data to record generated by the image sensor 35 and records the moving picture file generated on the memory card 130.

By pressing the menu button 39 and operating the touchscreen panel 37, the user can determine various camera settings.

The body microcomputer 10 is a controller that controls the overall operation of the camera body 3 and senses the user press or operate the still picture shooting button (i.e., shutter release button) 30, moving picture shooting button 110, menu button 39 or touchscreen panel 37. The body microcomputer 10 also has the function of sensing the interchangeable lens 2 be attached to the camera body 3 and the function of getting essential information to control this digital camera 1 from the interchangeable lens 2. Such essential information includes information about a variation in the zoom power of the image, information about the focal length and information about the lens attribute. Furthermore, the body microcomputer 10 sends control signals to control the group G2 of zoom lenses and the groups G4 and G5 of focus lenses to the lens microcomputer 40.

### 1-2. Operation

Hereinafter, it will be described exactly how this digital camera 1 operates.

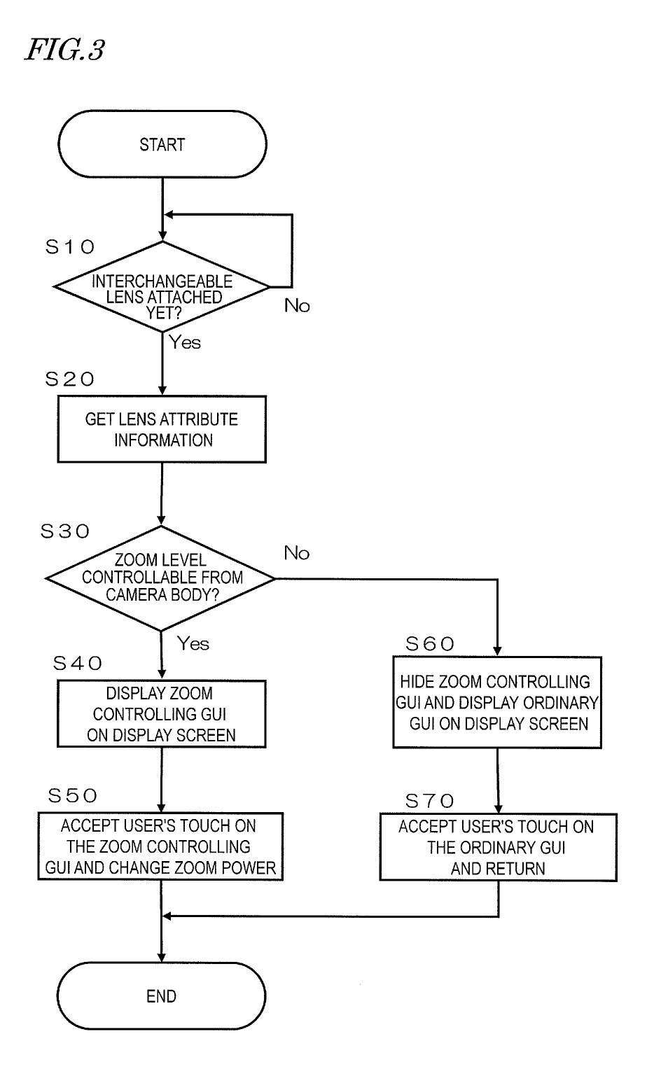

FIG. 3 is a flowchart illustrating how the images on the screen need to be changed as the interchangeable lens 2 is attached to the camera body 3.

First of all, in Step S10, the body microcomputer 10 determines whether or not the interchangeable lens 2 has been attached yet. This decision can be made by seeing if the body mount 4 is electrically continuous. Specifically, if the interchangeable lens 2 has been attached, then the lens mount 95 and the body mount 4 will contact with each other, thus changing the electrical state (i.e., the continuity) of the body mount 4. On sensing this variation, the body microcomputer 10 can determine that the interchangeable lens 2 has been attached. On the other hand, if the answer is NO, then the process goes back to the processing step S10 in a predetermined amount of time so that the body microcomputer 10 continuously checks out the status until the interchangeable lens is attached.

In this processing step, if the body microcomputer 10 has determined that any interchangeable lens has been attached, then the body microcomputer 10 communicates with the interchangeable lens attached, thereby getting its lens attribute information in Step S20. And by reference to that lens attribute information, the body microcomputer 10 can find the attribute of the interchangeable lens attached. In this case, the interchangeable lens 2 tells the body microcomputer 10 its own identification number and whether the motorized zoom operation is controllable from the camera body side as pieces of its lens attribute information. It should be noted that according to its type, the interchangeable lens attached may have no such function of transmitting its own lens attribute information. In that case, the body microcomputer 10 can determine, in a predetermined amount of time, that the lens attached is not controllable from the camera body side.

Furthermore, after having gotten the lens attribute information, the body microcomputer 10 determines, by reference to that lens attribute information, whether the zoom level of the interchangeable lens 2 attached is controllable from the camera body side (in Step S30). More specifically, the body microcomputer 10 determines whether or not the lens attribute information includes information about the controllability of the interchangeable lens' zoom operation from the camera body side.

In this case, if an interchangeable lens 2 that is controllable from the camera body side (such as the interchangeable lens 2 shown in FIG. 2) has been attached to the camera body 3, then the lens attribute information should include such information about the controllability of the interchangeable lens' zoom operation from the camera body side. Thus, the body microcomputer 10 can determine by reference to the lens attribute information gotten that the zoom level is controllable from the camera body side. In that case, the zoom controlling GUI shown in FIGS. 4 and 5 (to be described later) is displayed on the display section 20 (in Step S40).

The body microcomputer 10 retains in advance a piece of information that is used as a standard that designates interchangeable lenses, of which the zoom operation is controllable, in an internal buffer (not shown). That standard may be a list that describes the serial numbers of interchangeable lenses, of which the zoom operation is controllable. The body microcomputer 10 gets, as a piece of lens attribute information, information about the serial number of the interchangeable lens attached from the lens itself and compares that piece of lens attribute information to the list as the standard, thereby determining whether or not the operation of the interchangeable lens attached is controllable. And such a list may be an updatable one because a new interchangeable lens to be added to the list may go on sale in the near future.

Alternatively, the body microcomputer 10 may also be preprogrammed so as to operate on the supposition that the interchangeable lens attached can have its zoom operation controlled when receiving a particular value (which may be one, for example). On the other hand, when receiving any other value (which may be zero, for example) instead of the particular value, the body microcomputer 10 may operate on the supposition that the interchangeable lens attached cannot have its operation controlled. And when receiving the lens attribute information from the interchangeable lens, the body microcomputer 10 may compare that lens attribute information to the particular value as the standard information and may change its modes of operation based on a result of the comparison. That particular value for use in this processing step is retained in advance as the standard information in the internal buffer (not shown) of the body microcomputer 10.

The body microcomputer 10 gets such a zoom controlling GUI displayed on the display section 20 and starts performing a zoom level control on the group G2 of zoom lenses in the interchangeable lens 2 in response to the user's touch on the zoom controlling GUI.

When the user operates that zoom controlling GUI by putting his or her fingers on it, the camera accepts the user's operation of touching and changes zoom power on the interchangeable lens 2 (in Step S50).

FIG. 4 illustrates an example of the zoom controlling GUI.

In the example illustrated in FIG. 4, a slider bar that allows the user to select an arbitrary focal length is displayed as the zoom controlling GUI. The zoom controlling GUI includes an elongate rectangle 130, the left end of which indicates the wide angle focal length (which is labeled as “W end” in FIG. 4) and the right end of which indicates the telephoto focal length (which is labeled as “T end” in FIG. 4) and an indicator 131 indicating the current zoom level. The user puts his or her finger on that indicator 131 and then slides his or her fingertip either to the right or to the left. On sensing this touch operation, the body microcomputer 10 shifts the indicator 131 either to the right or to the left as instructed through the touch operation. And according to the position of that indicator 131, the body microcomputer 10 outputs a control signal to control the group of zoom lenses G2 to the lens microcomputer 40.

This GUI can be used effectively to shoot a still picture, because with such a slider bar, the user can choose his or her desired zoom power quickly when shooting a still picture.

As an alternative zoom controlling GUI, an icon 140 for changing the zoom level toward the wide angle focal length (which is labeled as “W” in FIG. 5) and an icon 141 for changing the zoom level toward the telephoto focal length (which is labeled as “T” in FIG. 5) may also be displayed on the right-hand side of the screen as shown in FIG. 5. When the user puts his or her finger on any of these icons, the body microcomputer 10 senses that touch operation and outputs a control signal to control the group of zoom lenses G2 to the lens microcomputer 40 in response to the touch operation.

If the GUI is displayed as buttons as shown in FIG. 5, this digital camera can be designed so as to change the focal length at a constant rate while any of those buttons is being pressed. Such a design is particularly effective when a moving picture is being shot. This is because when shooting a moving picture, the angle of view is preferably changed uniformly and gradually to make the moving picture shot easily viewable when it is played back.

And if the modes of operation are changed from the still picture shooting mode into the moving picture shooting mode, or vice versa, on the camera body 3, then the body microcomputer 10 may change the GUIs to display. Specifically, the body microcomputer 10 may change what to display on the screen so that the GUI shown in FIG. 4 is displayed when the still picture shooting mode is selected and that the GUI shown in FIG. 5 is displayed when the moving picture shooting mode is selected. Alternatively, instead of changing the GUIs according to the shooting mode, the user may choose his or her favorite GUIs in advance using the touchscreen panel 37 and the body microcomputer 10 may display the appropriate one of those GUIs chosen. Although the GUI to display is supposed to be chosen from the two according to preferred embodiment, the number of GUIs to choose one from may be three or more.

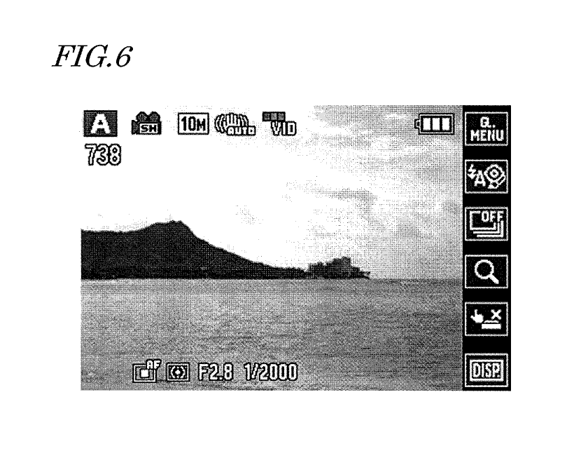

Next, it will be described what processing needs to be done if it has turned out in Step S30 that the zoom level of the interchangeable lens attached is not controllable from the camera body side. If such an interchangeable lens has been attached, the lens attribute information may not include information about the controllability of the interchangeable lens' zoom operation from the camera body side. Or in some cases, the lens attribute information itself may not be available. In that case, the body microcomputer 10 determines that the zoom level is not controllable from the camera body side, generates a normal GUI as shown in FIG. 6 and does not display the zoom controlling GUI as shown in FIG. 3 or 4 (in Step S60). That is to say, in such a situation, the GUI does not change before and after the interchangeable lens 2 is attached.

In such a situation, since no zoom controlling GUI is displayed, the zoom level of the interchangeable lens cannot be controlled through the touch operation but needs to be controlled by turning manually the zoom ring or any other fine adjustment means of the interchangeable lens, for example. Specifically, in that case, when the user operates the digital camera 1 either by pressing the buttons or by tapping the touchscreen panel 37 except the zoom control with fingers, the camera accepts the user's operation of touching and return to the original processing (in Step S70).

As described above, in the digital camera 1 of this preferred embodiment, the body microcomputer 10 determines whether or not the zoom level of the interchangeable lens attached is controllable from the camera body side. If the answer is YES, the body microcomputer 10 gets a zoom controlling GUI displayed on the display section 20. Otherwise, the body microcomputer 10 gets an ordinary touch user interface displayed on the display section 20. According to this scheme, the zoom controlling GUI is displayed if the interchangeable lens attached can have its zoom level controlled from the camera body side but is not displayed otherwise. That is to say, the zoom controlling GUI is displayed only when needed and not displayed when unnecessary. Consequently, the display section 20 can be used more effectively.

The preferred embodiments of the present invention described above are only examples of the present invention and various modifications or variations can be readily made on them without departing from the true spirit and scope of the present invention. Also, those preferred embodiments are essentially nothing but illustrative ones. Therefore, it is never intended that the foregoing description of preferred embodiments of the present invention limits the applications of the present invention or their range.

In the preferred embodiments of the present invention described above, the body microcomputer 10 is supposed to determine whether or not to display the zoom controlling GUI on sensing that an interchangeable lens 2 has been attached. However, this is only an example of the present invention. Optionally, the body microcomputer 10 may get the zoom controlling GUI shown on the display section 20 on sensing that an interchangeable lens, of which the zoom level is controllable from the camera body side, has been attached and may make the zoom controlling GUI disappear from (i.e., not shown on) the display section 20 on sensing that such an interchangeable lens, of which the zoom level is controllable from the camera body side, has been removed.

Also, in the preferred embodiments described above, the GUI such as the one shown in FIG. 4 or 5 is supposed to be displayed as the zoom controlling GUI. However, the present invention is in no way limited to those specific preferred embodiments. Rather any other zoom controlling GUI may also be displayed as long as the zoom level of the interchangeable lens 2 can be controlled by performing a touch operation on the touchscreen panel 37. For example, a GUI corresponding to a button for simply changing the zoom level toward either the wide angle focal length or the telephoto focal length may be displayed. Or multiple different kinds of zoom controlling GUIs may be stored in advance in the camera body 3 and the user may choose one of those GUIs through the menu, for example.

Furthermore, in the preferred embodiments described above, the zoom controlling GUI is supposed to be displayed on the display section 20 on sensing that the interchangeable lens attached can have its zoom level controlled from the camera body side. However, a similar operation may also be performed on any other target of control. For example, a focus controlling GUI may be displayed on the display section 20 on sensing that the interchangeable lens attached can have its focus position controlled from the camera body side. In that case, the interchangeable lens transmits lens attribute information, including information indicating that the focus position can be controlled from the camera body side, to the body microcomputer 10. In accordance with that information, the body microcomputer 10 displays a focus controlling GUI on the display section 20. Also, as soon as such an interchangeable lens is removed, the focus controlling GUI may get hidden from view on the display section 20. Optionally, if the focus control mode is set to be an autofocus mode, the focus controlling GUI does not have to be shown on the display section 20 even when the body microcomputer 10 senses that the interchangeable lens attached can have its focus position controlled from the camera body side. On the other hand, if the focus control mode is set to be a manual focus mode, the focus controlling GUI may be shown on the display section 20 when the body microcomputer 10 senses that the interchangeable lens attached can have its focus position controlled from the camera body side.

Optionally, if the interchangeable lens itself has an optical image stabilization (OIS) function, a controlling GUI for turning that OIS function ON or OFF may be displayed.

In the foregoing description of preferred embodiments of the present invention, it has been described what processing needs to be done if an interchangeable lens 2 has been attached to the camera body 3. However, the present invention is in no way limited to those specific preferred embodiments. Rather, the present invention is also applicable more generally to a situation where a piece of equipment for use to shoot video or record audio has been attached to an image capture device. Hereinafter, examples of such applications of the present invention will be described.

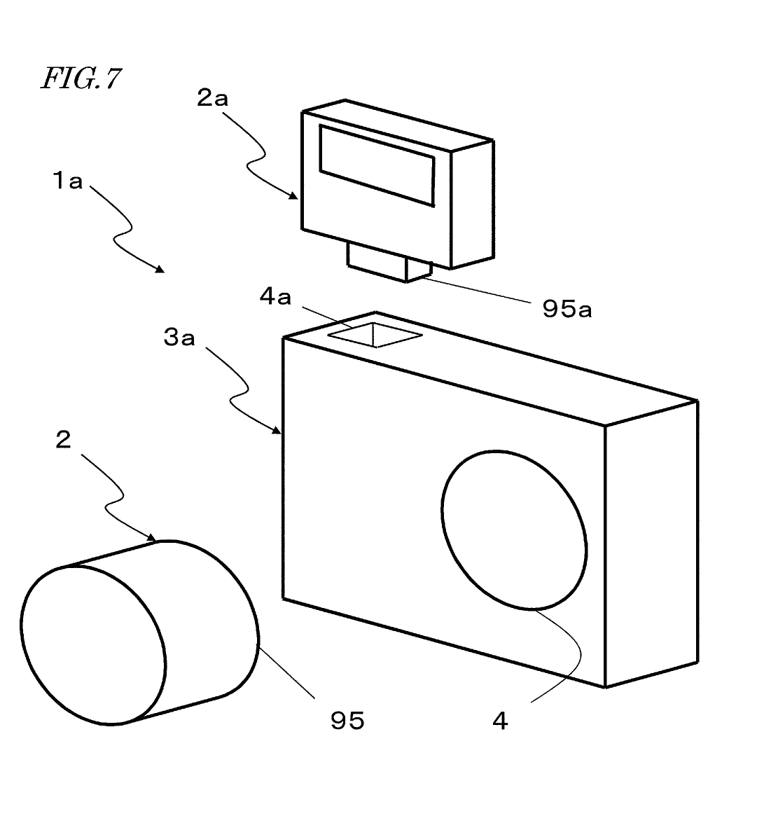

For example, FIG. 7 illustrates a digital camera 1a that has a camera body 3a, to which not only the interchangeable lens 2 but also a flash unit 2a are attachable. The camera body 3a has a mount 4a on its top surface. The flash unit 2a has its mount 95a fitted into the mount 4a on the top surface of the camera body 3a. In this example, the interchangeable lens 2 has the same structure and function as the one shown in FIGS. 1 and 2, and the description thereof will be omitted herein. The internal configuration of the camera body 3a is also just as shown in FIG. 2, and will not be described all over again.

Just like interchangeable lenses, there are a lot of flash units that are controllable from the camera body side. If the flash unit 2a is one of them, the body microcomputer 10 of the camera body 3a communicates with, and gets property information from, that flash unit 2a. And in accordance with that property information, the display section 20 displays a user interface for controlling firing of the flash unit 2a.

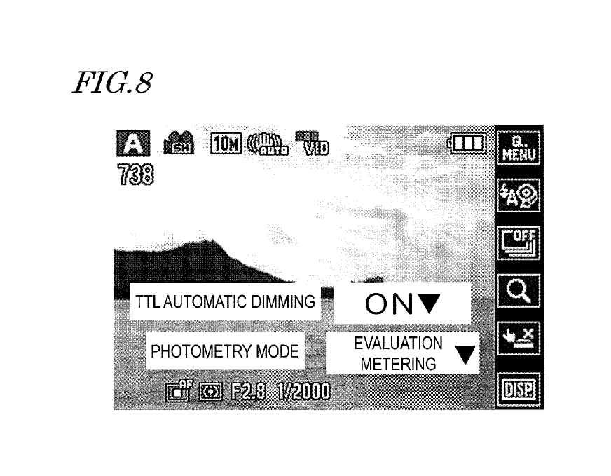

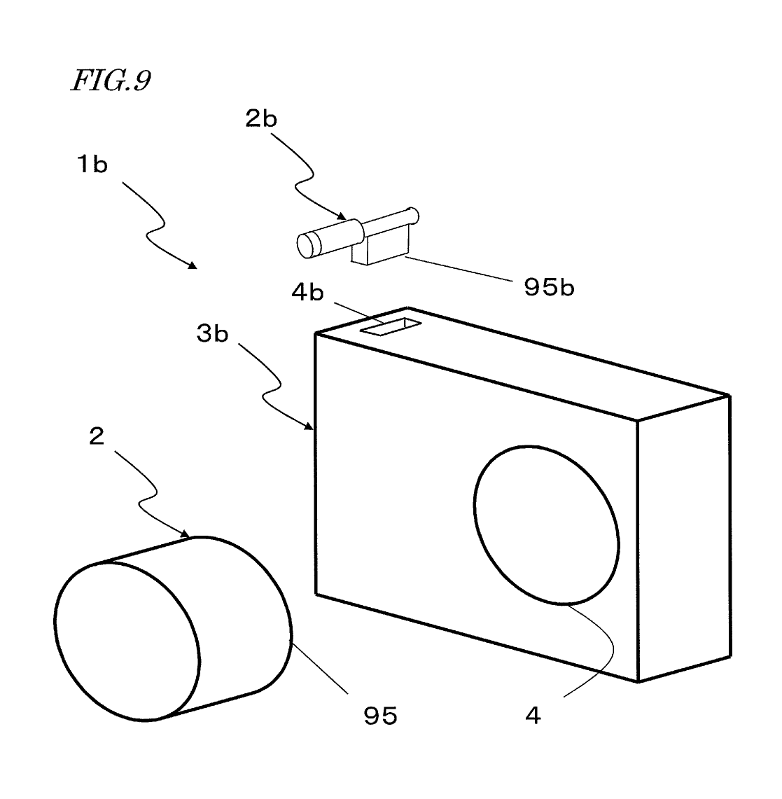

FIG. 8 illustrates an exemplary GUI for controlling firing of the flash unit 2a. In this example, the flash unit 2a is supposed to operate in a TTL automatic dimming mode and an evaluation metering mode is selected.

Next, it will be described what if a microphone is attached to an image capture device according to the present invention. FIG. 9 illustrates a digital camera 1b that has a camera body 3b, to which a microphone 2b is attachable. The camera body 3b has a mount 4b on its top surface. The microphone 2b has its mount 95b fitted into the mount 4b on the top surface of the camera body 3b. In this example, the interchangeable lens 2 has the same structure and function as the one shown in FIGS. 1 and 2, and the description thereof will be omitted herein. The internal configuration of the camera body 3b is also just as shown in FIG. 2, and will not be described all over again.

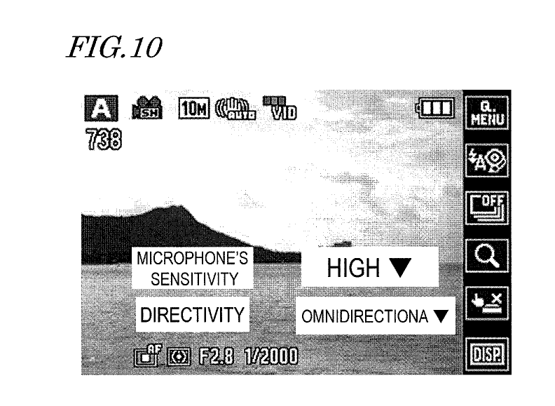

FIG. 10 illustrates an exemplary GUI for controlling the microphone 2b. In this example, the microphone 2b is supposed to operate with high microphone sensitivity and the directivity is supposed to be omnidirectional.

In each of the modified examples of the present invention described above, the interchangeable lens 2 is included. However, the interchangeable lens 2 is not an indispensable component in any of those examples.

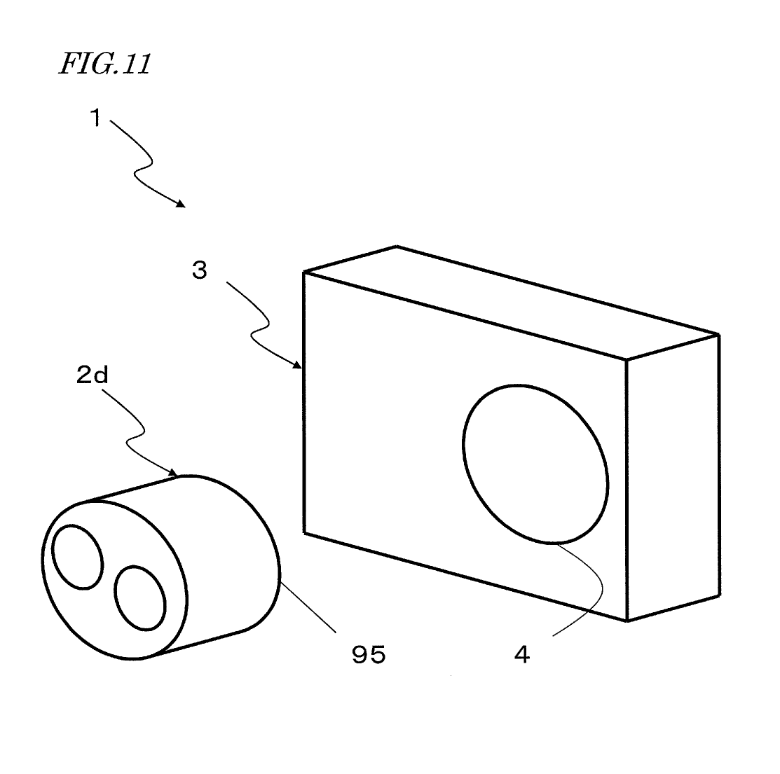

Next, it will be described how a 3D conversion lens may be attached to an image capture device according to the present invention. FIG. 11 illustrates a digital camera 1 that has a camera body 3, to which a 3D conversion lens 2d is attachable. In this example, the 3D conversion lens 2d is attached instead of the interchangeable lens 2 shown in FIG. 1.

This 3D conversion lens 2d has two lenses to obtain a right-eye image and a left-eye image, and the light beams that have passed through those two lenses (and produced two subject images) are combined together in the camera body.

If such a 3D conversion lens 2d has been attached, the body microcomputer 10 of the camera body 3 communicates with, and gets property information from, that 3D conversion lens 2d. And the body microcomputer 10 gets a GUI for controlling the function of the 3D conversion lens 2d displayed on the display section 20. The GUI may be an optical axis controlling GUI for aligning the respective optical axes of the right and left lenses with each other, for example.

As already mentioned at the beginning of this description of this preferred embodiments, the image capture device of the present invention may be not only a still picture shooting device such as a digital still camera but also a moving picture shooting device such as a camcorder. The processing of the image capture device described above (and shown in FIG. 3) can be carried out by making the body microcomputer 10 (see FIG. 2) execute a computer program that is stored in its internal memory (not shown) and operating the respective components of the interchangeable lens 2 and the camera body 3. Such a computer program may be circulated on the market by being stored on a storage medium such as a CD-ROM or downloaded over telecommunications lines such as the Internet. Microcomputers, such as microcomputer 10 and lens microcomputer 40, are known as processors.

The image capture device of the present invention can provide user interfaces that are much easier to use for general consumers, and therefore, can be used effectively in digital cameras, digital camcorders and sundry other electronic devices.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2010-241631 filed on Oct. 28, 2010, the entire contents of which are hereby incorporated by reference.

What is claimed is:

1. An image capture device, to/from which a piece of equipment for use to shoot video or record audio is attachable and removable, the device comprising:
a communications section adapted to get, when such a piece of equipment is attached to the device, property information of the piece of equipment;
a processor adapted to determine, by reference to the property information, whether a user interface to control the operation of the piece of equipment needs to be displayed or not;
a display section adapted to display the user interface when instructed by the processor to do so; and
a touchscreen panel adapted to allow the user to operate the user interface.

2. The image capture device of claim 1, wherein the piece of equipment is an interchangeable lens, and
wherein the communications section communicates with the interchangeable lens to get the property information from the interchangeable lens, and
wherein the display section displays the user interface to control the interchangeable lens' operation.

3. The image capture device of claim 2, wherein by reference to the property information, the processor determines that the user interface to control the interchangeable lens' operation needs to be displayed, and
wherein the display section does display the user interface as instructed by the processor.

4. The image capture device of claim 3, wherein in response to the user's touch on the touchscreen panel while the user interface is being displayed on the display section, the processor controls the interchangeable lens' operation.

5. The image capture device of claim 4, wherein the interchangeable lens is a zoom lens, and
wherein in response to the user's touch on the touchscreen panel, the processor controls the focal length or zoom power of the zoom lens.

6. The image capture device of claim 4, wherein the processor is able to display one of multiple different kinds of user interfaces that have been prepared in advance.

7. The image capture device of claim 6, wherein the image capture device is able to change its modes of operation from a still picture shooting mode into a moving picture shooting mode, and vice versa, and
wherein the display section displays a first user interface while the device is operating in the still picture shooting mode and displays a second user interface, which is different from the first user interface, while the device is operating in the moving picture shooting mode.

8. The image capture device of claim 6, wherein the processor displays one of the multiple different kinds of user interfaces that has been chosen by the user.

9. The image capture device of claim 7, wherein the first user interface includes a slider bar that allows the user to select an arbitrary focal length, and
wherein the second user interface includes a button that allows the user to change the focal length at a constant rate while being pressed down.

10. The image capture device of claim 1, wherein the piece of equipment is a flash unit, and
wherein the communications section gets the property information from the flash unit, and
wherein the display section displays a user interface to control the flash unit's firing.

11. The image capture device of claim 1, wherein the piece of equipment is a microphone, and
wherein the communications section gets the property information from the microphone, and
wherein the display section displays a user interface to control at least one of the sensitivity and the directivity of the microphone.

12. The image capture device of claim 1, wherein the piece of equipment is a 3D conversion lens, and
wherein the communications section gets the property information from the 3D conversion lens, and
wherein the display section displays a user interface to control at least one of the two optical axes of the 3D conversion lens that are associated with a right-eye image and a left-eye image, respectively.

13. The image capture device of claim 1, wherein the processor retains a standard that designates pieces of equipment, of which the operation is controllable for the processor, and
wherein by comparing the property information to the standard, the processor determines whether or not the processor is able to control the operation of the piece of equipment attached.

14. The image capture device of claim 13, wherein the processor retains, as the standard, a list of pieces of equipment, of which the operation is controllable for the processor.

15. The image capture device of claim 13, wherein the processor retains standard information as the standard, and
wherein if the property information gotten agrees with the standard information, the processor finds the operation of the piece of equipment attached controllable.
